(19) United States
(12) Patent Application Publication
(10) Pub. No.: US 2024/0261603 A1
(43) Pub. Date: Aug. 8, 2024

(54) VALVE ASSEMBLY

(71) Applicant: GLOBUS (SHETLAND) LIMITED, Manchester (GB)

(72) Inventor: Joshua MOFFAT, Manchester (GB)

(21) Appl. No.: 18/569,475

(22) PCT Filed: Jun. 15, 2022
(86) PCT No.: PCT/GB2022/051504

§ 371 Date: Dec. 12, 2023

(30) Foreign Application Priority Data
Jun. 16, 2021 (GB) 2108588.1

(51) Int. Cl. A62B 18/10

(52) U.S. Cl. CPC A62B 18/10

(57) ABSTRACT

The present application describes a unidirectional valve assembly (100) for a face mask, comprising a valve seat member (104) providing a continuous valve seat surface (156) surrounding a non-circular valve orifice (116), and a plurality of cross members (162) each extending partially across the valve orifice to meet at an intersection region; a substantially flexible and cantilevered valve flap (106) mounted at a fixed end region (108) to the valve seat member and configured to engage the valve seat when in a closed position to prevent air flow through the valve assembly; and a valve cover member (102) attached to the valve seat member and defining a plurality of apertures (178, 180,182) in fluid communication with the valve orifice when at least a free end region (110) of the valve flap is in an open position with respect to the valve seat to allow air flow through the valve assembly, wherein the cross members (162) are arranged in a Y-shape configuration.

The present invention relates to a valve assembly for a face mask and in particular, but not exclusively, to a unidirectional exhalation valve assembly for a filtering face mask.

It is known for people to wear filtering face masks in environments wherein a risk of inhaling potentially hazardous airborne contaminants exists. Such face masks typically include a cup-shaped mask body for locating over the mouth and nose of a wearer and a valve assembly mounted in an aperture of the mask body proximal to the mouth of the wearer. The valve assembly typically includes a valve element configured to allow one-way or unidirectional flow of air into or out of the mask body in response to an inhalation or exhalation of air by the wearer which creates a pressure differential across the valve element to thereby urge the same towards an open position and allow air into or out of the mask body accordingly.

Conventional valve assemblies for face masks typically include a circular valve orifice defining a circular valve seat for a circular valve element to engage when in the closed position. The circular valve element is flexible and typically mounted at its centre such that the circumferential edge of the valve element is urged away from the valve seat when in an open position and back onto the valve seat when in a closed position. However, such a configuration requires a relatively high-pressure differential to be created across the valve to open the valve element, mainly because the distance from the central mounting point to the edge of the circular valve element is relatively small. Circular diaphragm valves also create a significant amount of air flow resistance through the valve assembly and in turn increased breathing resistance to a wearer which can become uncomfortable, particularly in a relatively hot environment.

Cantilever flap valves have been developed to address the abovementioned problems associated with circular diaphragm valves, such as described in EP1962964. Whilst a cantilevered flap valve presents less of an obstruction and in turn resistance to airflow through the valve assembly, conventional flap valves are substantially thin and flexible and can move away from the valve seat when the valve assembly is inverted for example which undesirably creates a leak path for potentially hazardous airborne contaminants to enter into the mask body. Furthermore, it is known to provide a crucifix arrangement of cross members extending across the valve orifice to prevent the flap valve flexing beyond the closed position and inverting. However, these cross members increase the resistance to airflow through the valve and do not sufficiently support the valve flap to prevent a leak path for potentially hazardous airborne contaminants to enter into the mask body.

It is an aim of certain embodiments of the present invention to provide a respirator valve for a filtering face mask wherein the valve is configured to minimise resistance to airflow through the valve in use, whilst also minimising a pressure differential required across the valve to open a valve flap thereof.

It is an aim of certain embodiments of the present invention to provide a respirator valve for a filtering face mask wherein a valve flap of the valve is biased in a closed position against a valve seat of the valve when a pressure differential across the valve is zero and the valve is in any orientation, such as inverted, whilst also minimising a pressure differential required across the valve to open the valve flap during inhalation or exhalation by a wearer of the face mask.

According to a first aspect of the present invention there is provided a unidirectional valve assembly for a face mask, comprising:
a valve seat member providing a continuous valve seat surface surrounding a non-circular valve orifice, and a plurality of cross members each extending partially across the valve orifice to meet at an intersection region;
a substantially flexible and cantilevered valve flap mounted at a fixed end region to the valve seat member and configured to engage the valve seat when in a closed position to prevent air flow through the valve assembly; and
a valve cover member attached to the valve seat member and defining a plurality of apertures in fluid communication with the valve orifice when at least a free end region of the valve flap is in an open position with respect to the valve seat to allow air flow through the valve assembly,
wherein the cross members are arranged in a Y-shape configuration and comprise a first cross member extending from a first corner region of the valve orifice, a second cross member extending from a second corner region of the valve orifice, and a third cross member extending substantially longitudinally with respect to an axis of the valve flap and away from the first and second corner regions of the valve orifice.

Optionally, the valve orifice is substantially square.

Optionally, the cross members split the valve orifice into a pair of opposed first and second side ports extending from a proximal end of the orifice towards a distal end of the orifice with respect to the fixed end region of the valve flap, and a distal end port extending across the distal end of the orifice.

Optionally, the plurality of apertures of the valve cover member comprises a first side aperture substantially aligned with the first side port, a second side aperture substantially aligned with the second side port, and a distal end aperture substantially aligned with the distal end port.

Optionally, the valve cover member comprises a pair of opposed corner apertures each located between the distal end aperture and a respective one of the side apertures.

Optionally, the apertures are disposed in a wall region of the valve cover member and a closure region extends across the wall region to close the valve assembly distal and substantially opposed to the valve orifice.

Optionally, a plurality of spaced apart and parallel ribs extends inwardly towards the valve orifice from an inner surface of the closure region.

Optionally, the ribs are oriented substantially laterally with respect to the longitudinal axis of the valve flap.

Optionally, the valve seat surface comprises a pair of opposed side regions extending between proximal and distal end regions with respect to the fixed end region of the valve flap, and wherein the side regions of the valve seat surface are substantially concave.

Optionally, the distal end region of the valve seat surface is located further away from the valve orifice than the proximal end region of the valve seat surface in a direction parallel to an axis of the valve orifice.

Optionally, a flap support surface defined by the cross members is substantially concave and defines a curvature substantially corresponding to the curved side regions of the valve seat surface.

Optionally, a width of the flap support surface along each cross member is less than a width of an underlying main portion of each cross member.

Optionally, the flap support surface is spaced apart from the valve seat surface.

Optionally, the intersection region of the cross members is offset with respect to a centre of the valve orifice.

Optionally, the valve seat surface surrounding the valve orifice is substantially square.

Optionally, the valve seat member comprises a mounting surface for mounting the fixed end region of the valve flap on, and the valve cover member comprises a clamping portion for clamping the fixed end region of the valve flap between the valve seat member and the valve cover member.

Optionally, the clamping portion comprises an elongate projection extending laterally across the valve flap.

Optionally, the mounting surface of the valve seat member and a clamping surface of the clamping portion are angled to urge the free end region of the valve flap towards the valve seat surface.

Optionally, the valve seat member comprises a pair of laterally spaced apart projections extending from the mounting surface each located in a corresponding notch disposed in a respective side edge of the fixed end region of the valve flap.

Optionally, the valve seat member comprises a central projection extending from the mounting surface located in a notch disposed in an end edge of the fixed end region of the valve flap.

Optionally, the valve cover member comprises a plurality of spaced apart projections for locating in corresponding apertures of the valve seat member during assembly, wherein the material of the projections is configured to melt on heating and fuse with the material of the apertures to provide a homogenous weld on cooling to securely attach the valve cover member to the valve seat member.

Optionally, each aperture comprises a countersunk region and each projection is configured to extend through the respective aperture before heating and to fill the countersunk region when molten to thereby create a tapered formation at the end of each projection.

Optionally, the valve flap is a monolithic polymeric element.

According to a second aspect of the present invention there is provided a face mask comprising a unidirectional valve assembly according to the first aspect of the present invention.

Optionally, the valve assembly is configured to allow a wearer of the mask to exhale through the valve assembly.

### DESCRIPTION OF THE DRAWINGS

Certain embodiments of the present invention will now be described with reference to the accompanying drawings in which:

FIG. 1 illustrates an exploded isometric top view of a respirator valve assembly according to a first embodiment of the present invention;

FIG. 2a illustrates a sectional view through the valve assembly of FIG. 1 when assembled;

FIG. 2b illustrates a detailed sectional view proximal to the free end of the flap valve;

FIG. 3 illustrates a bottom view of the valve assembly of FIG. 2a;

FIG. 4 illustrates an exploded isometric top view of a respirator valve assembly according to an alternative embodiment of the present invention;

FIG. 5 illustrates an exploded isometric bottom view of the respirator valve assembly of FIG. 4;

FIG. 6 illustrates a close-up bottom view of a corner region of the valve assembly of FIG. 5 before a cover member and a seat member of the valve assembly have been welded together; and

FIG. 7 illustrates a close-up bottom view of the corner region of FIG. 6 after the cover member and the seat member of the valve assembly have been welded together.

### DETAILED DESCRIPTION

As illustrated, a respirator valve assembly 100 for a filtering face mask includes two interconnecting housing members referred to herein as a valve cover member 102 and a valve seat member 104. The housing members 102,104 are injection moulded from a plastics material, such as polypropylene or the like.

A polymeric valve flap 106 is clamped at a fixed end region 108 thereof between the valve cover member 102 and the valve seat member 104 when the two components are connected together by suitable means, such as bonding, adhering, welding, an interference fit, or a mechanical fixing or coupling, e.g. a snap-fit connection, or the like. The valve flap 106 is substantially flexible to allow a free end region 110 of the valve flap 106, and at least partially a central region 112 of the valve flap, to move from a closed position towards an open position with respect to the valve seat member 104 in response to a pressure differential being created across the valve flap when a wearer of the face mask exhales. The valve flap 106 is substantially resilient to urge at least the free end region 110 back to the closed position when the pressure differential across the valve flap is zero. Furthermore, as described further below, the valve flap 106 is also mechanically biased towards the valve seat member 104 and in turn the closed position. The valve flap 106 is aptly a mono layer or monolith element and has a thickness of around 0.045 mm to 0.08 mm. Aptly, the valve flap 106 material has a density of around 1200 kg/m\hat{ }3 to 1500 kg/m\hat{ }3, ideally around 1244 kg/m\hat{ }3 which desirably provides a relatively lightweight valve flap for a given length and width which is aptly around 32×27 mm respectively. Desirably, a relatively lightweight valve flap requires less force to move a given distance, thereby reducing the required pressure differential across the valve and required breathing effort from a wearer of the face mask. Suitable polymeric materials for the valve flap 106 include polyethylene terephthalate (PET) or high-density polyethylene (HDPE) or the like.

The valve seat member 104 includes a substantially square base portion 114 defining a substantially square orifice 116. The orifice may be a different non-circular shape such as rectangular or trapezoid for example but a substantially square orifice is preferred because such a shape maximises orifice area, and in turn airflow therethrough, whilst minimising resistance to the airflow and the size of the valve assembly. ‘Substantially square’ is intended to mean a shape having a maximum width dimension that is substantially similar if not identical to a maximum length dimension of the orifice, wherein opposed sides of the shape may be parallel or not and the four corner regions of the shape may be curved having the same or different radii of curvature. A continuous first wall portion 118 extends substantially perpendicularly from the base portion 114 to surround the orifice 116. An outer surface 120 of the wall portion 118 is optionally tapered to engage by an interference fit with a correspondingly tapered inner surface 122 of the valve cover member 102 when the two components are connected together. The first wall portion 118 is located inboard of the outer edge of the base portion 114 such that a continuous flange surface 124 is provided around the valve seat member 104 for engagement with a corresponding flange surface 126 of the valve cover member 102 when the two components are connected together. The connected flange regions of the valve cover member and the valve seat member provide a flange portion for engagement with an outer surface of the body of the face mask.

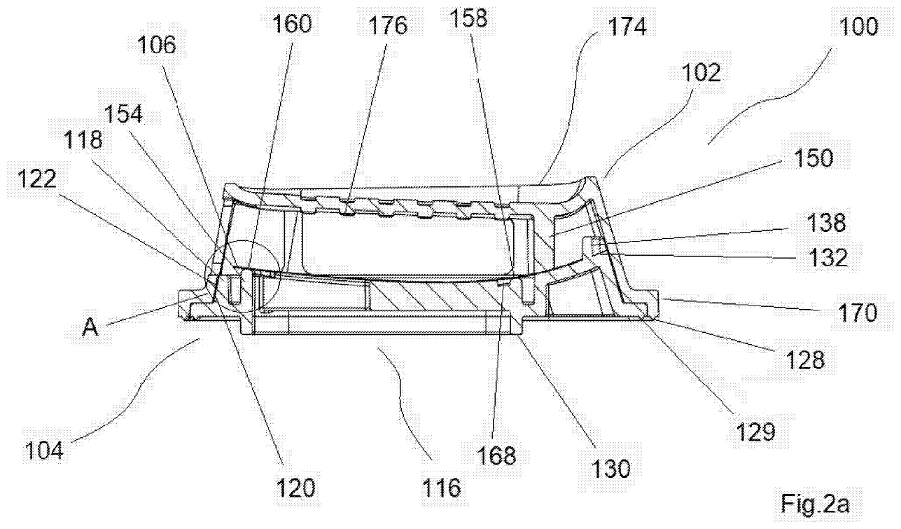

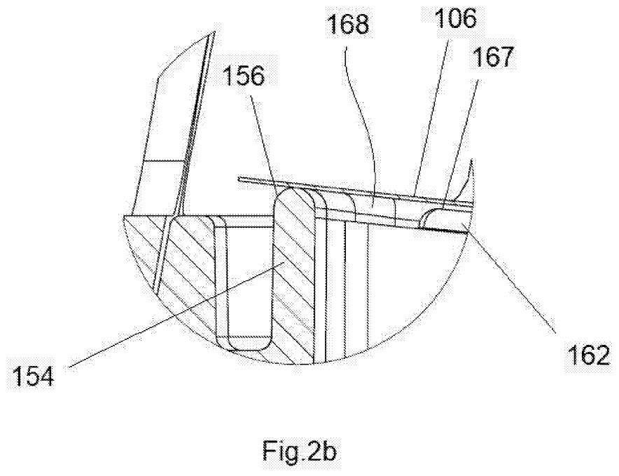

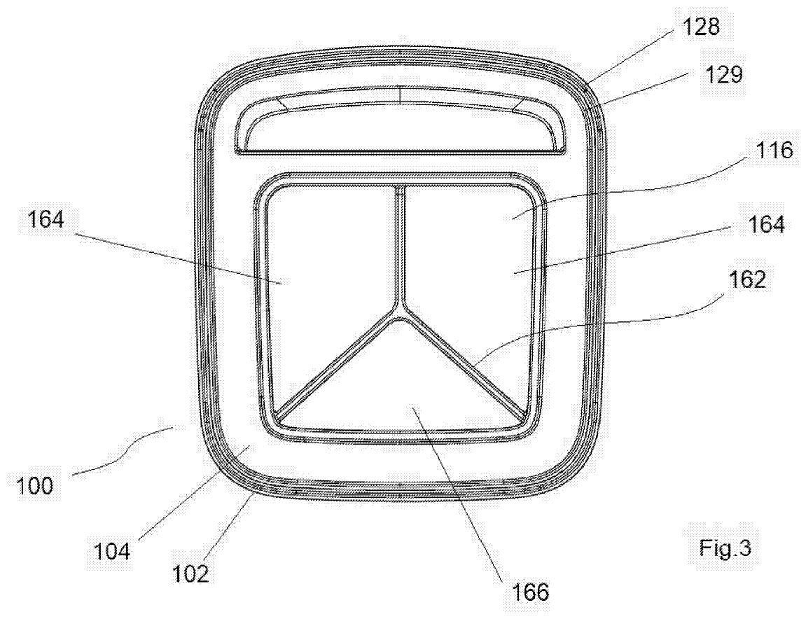

As illustrated in FIGS. 2a and 3, a continuous projection 128, 129 is provided around each of the flanges of the valve seat member and the valve cover member such that the projections are adjacent to each other and spaced apart when the two components are connected together to thereby define an outer one 128 and an inner one 129 of the continuous projections. The projections 128,129 taper to an apex and engage into/on the outer surface of the mask body when the valve assembly is located thereon during assembly of the mask. A lower wall portion 130 of the valve seat member 104 extends around the orifice 116 for engagement in a correspondingly shaped aperture provided in the mask body to thereby ensure the valve assembly is correctly located and securely mounted on the mask body. Heat is applied proximal to the projections 128, 129 to cause the plastics material to melt and homogenously fuse or weld the valve cover member 102 and the valve seat member 104 locally together, whilst also securing the valve assembly 100 to the mask body when the molten plastics material solidifies. This allows the valve assembly to be secured to the face mask in a relatively quick and efficient manner whilst, at the same time and by the same operation, securely connecting the two main components of the valve assembly together.

A proximal end region of the first wall portion 118 with respect to the fixed end of the valve flap 106 is wider than the distal end region and side regions of the first wall portion 118. The proximal end region of the first wall portion 118 provides a substantially curved mounting surface 132 for engagement with an inner surface of the valve flap 106 at the fixed end region 108 thereof. A pair of laterally spaced apart projections 134 extend upwardly from each side of the mounting surface 132 for engagement in a corresponding notch 136 provided in each side of the fixed end region 108 of the valve flap 106. The notch and projection arrangement constrains the valve flap 106 in both lateral and longitudinal directions with respect to the valve seat member 104. A further projection 138 is provided on the mounting surface 132 and substantially centrally and proximal to an outer edge thereof. A further notch 140 is provided in the fixed end edge of the valve flap 106 for the central projection 138 to engage in when the valve flap 106 is mounted on the mounting surface 132. The central notch and recess arrangement acts as a further locator for mounting the valve flap on the valve seat member in a correct orientation and location, whilst also providing additional security and constraint to the valve flap in both longitudinal and lateral directions. The inner surfaces of the projections are convex to engage with corresponding concave surfaces of the respective notches. The curves engagement surfaces ensure any stress concentrations and potential fatigue locations on the valve flap are minimised, whilst providing maximum contact area between the fixed end region of the valve flap and the projections for optimum security and constraint.

As illustrated in FIG. 2a, a clamping portion 150 in the form of a laterally oriented and elongate projection extends inwardly from a closure region 174 of the valve cover member 102 towards the valve seat member 104 and engages the outer surface of the valve flap 106 to clamp the same between the valve cover member 102 and the valve seat member 104. The clamping portion 150 has an angled surface at its free end which engages the valve flap and corresponds to the angle of the mounting surface 132 at that location to efficiently clamp the valve flap 106 therebetween. The angle of the mounting surface 132 at the clamp location is around 10-30 degrees with respect to the horizontal, and aptly around 19 degrees. An inner surface of the clamping projection 150 vertically aligns with the inner surface of the proximal end region of the first wall portion 118 to thereby define a continuous hinge line laterally across the valve flap 106 about which the valve flap flexes when moving between the open and closed positions with respect to the valve seat in use. The clamping projection 150 is longitudinally spaced from the locating projections 134,138 towards the free end region 110 of the valve flap 106 to thereby, in combination with the angled/curved mounting surface 132, urges or biases the valve flap 106 towards the closed position and against a valve seat of the valve seat member 104, as described further below.

The first wall portion 118 of the valve seat member 104 is located inboard of the inner edge of the base portion 114 which defines the orifice 116. A second wall portion 154 is provided between the orifice 116 and the first wall portion 118 and extends substantially perpendicularly from the base portion 114 and surrounds the orifice. An inner surface of the second wall portion 154 is vertically aligned with an inner surface of the lower wall portion 130 to provide a continuous orifice inner surface. The first and second wall portions 118,154 are spaced apart to define a gap therebetween. An upper surface of the second wall portion 154 provides a continuous valve seat surface 156 for the valve flap 106 to sealingly engage with when in the closed position. As illustrated in FIG. 2b, the valve seat surface 156 is substantially convex, and aptly semi-circular in cross section, to minimise the contact area between the seat surface and the valve flap whilst efficiently sealing the valve flap against the seat surface when in the closed position. The substantially rounded seat surface minimises the effects of any forces acting between the seal surface and the valve flap which could prevent the same from efficiently opening from the closed position, such as if moisture accumulated on a substantially flat seat surface which could undesirably cause the valve flap to stick to the seat surface in use.

The substantially square valve seat surface 156 comprises opposed end surfaces and opposed side surfaces with respect to a longitudinal axis of the valve flap 106 in a direction from the fixed end region 108 to the free end region 110 thereof. The valve seat surface 156 has a material hardness of around at least around 0.05 GPa, and aptly around 0.08 GPa, to provide a substantially rigid seal surface against which the valve flap engages in use to create an effective seal. Hardness testing was conducted using a Hysitron Ti950 nano-indenter and a standard diamond Berkovich probe. The second wall portion 154 defining the seat surface is around 0.75 mm wide.

As illustrated in FIG. 2a, the side surfaces of the valve seat 156 are substantially concave, whilst the end surfaces of the valve seat 156 are substantially flat and parallel. This configuration allows the valve flap 106 to flex longitudinally only, i.e. not laterally, and engage with the longitudinally curved side surfaces of the valve seat 156 in a relatively natural and low strained manner to ensure an efficient and consistent seal is created between the valve flap and the valve seat in use. A proximal end surface 158 of the valve seat 156 with respect to the fixed end of the valve flap 106 is lower than a distal end surface 160 of the valve seat when viewed in cross section as illustrated in FIG. 2a. In combination with the valve flap 106 being biased towards the closed position by the arrangement of the curved mounting surface 132 and the clamping projection 150, the higher distal end surface 160 increases the seal force, particularly at the free end region of the valve flap, to provide an efficient and effective seal between the valve seat member and the valve flap and particularly in any orientation of the valve assembly, such as when inverted, to prevent the valve flap undesirably opening when a zero pressure differentiation is across the valve.

Three elongate cross members 162 extend across the orifice 116 to add strength and stiffness to the valve seat member 104. The cross members 162 are arranged in a Y-shape configuration such that two of the cross members extend inwardly from a respective one of the distal corner regions of the orifice towards the longitudinal axis (proximal-distal direction) of the orifice, and a third cross member extends along the longitudinal axis to the proximal end of the orifice. The cross members 162 extend inwardly from the second wall portion 154 which provides the valve seat surface 156. Aptly, the cross members 162 meet at an intersection region which, as illustrated in FIG. 2, is offset, i.e. not coaxial, with respect to a central axis of the valve orifice 116. This defines two relatively large proximal or side ports 164 of equal size and one smaller distal or end port 166. Furthermore, the area of the smaller port decreases in the proximal direction, i.e. away from the free end of the valve flap, whereas the area of the larger ports increases in the proximal direction. When the valve flap is open, the free end region thereof will flex further away from the valve seat surface than the central region of the valve flap and yet further away than a proximal region of the valve flap near the fixed end region thereof, so this arrangement aims to promote substantially equal and balanced air flow through the valve assembly when the valve flap 106 is open. Alternatively, the intersection region of the cross members may be substantially coaxial, i.e. aligned, with a centre of the orifice. Providing three cross members 162 in the Y-shape arrangement also sufficiently strengthens and stiffens the valve seat member 104 whilst minimising the resistance to air flowing through the valve assembly in use compared to, for example, a cruciform arrangement.

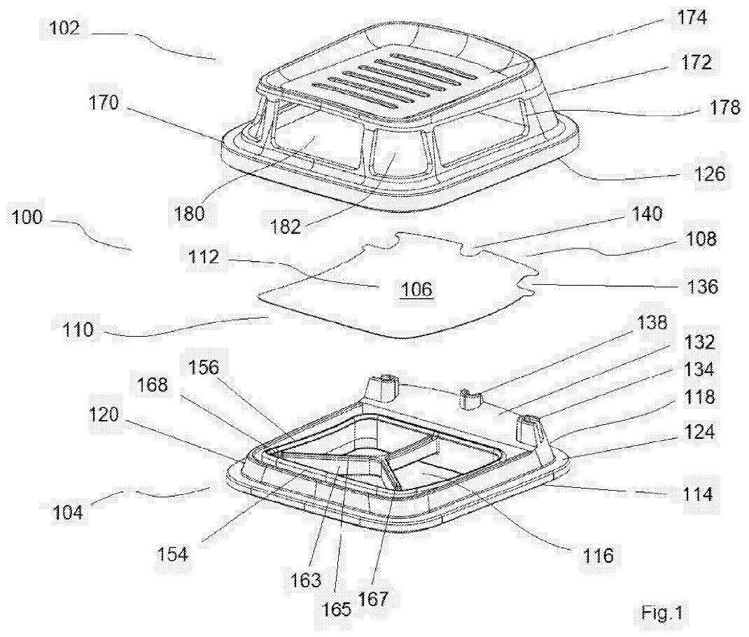

As illustrated in FIGS. 1 and 2a, each cross member 162 includes a main portion 163 extending from a respective region of the valve orifice 116 and a flap support portion 165 each defining a support surface 167 for engagement with the valve flap 106 when in an ‘over-closed’ position. An ‘over-closed’ position refers to the valve flap being urged by a pressure differentiation created across the flap during inhalation by a wearer which causes the central region of the flap to bend beyond the closed position (‘neutral/normal’ engagement with the valve seat). The cross members 162 act to the support and limit this movement of the flap beyond the closed position and prevents the same collapsing or buckling during inhalation by the wearer. As illustrated in FIG. 2a, the support surfaces 167 of each cross member 162 are substantially curved in a longitudinal direction of the valve flap to provide a combined concave surface which substantially follows the curvature of the mounting surface 132. A radius of curvature of the valve seat surface 156 and the Y-shaped support surface 167 may be substantially the same as the mounting surface 132 on which the fixed end region of the valve flap 106 is mounted. Alternatively, the curvature of the valve seat surface and the Y-shaped support surface may tend towards the horizontal (as viewed in FIG. 2a) whilst optionally not reaching the horizontal.

The support surfaces 167 are aptly distanced slightly below, i.e. inwardly, from the valve seat surface 156 such that they are offset from the valve flap when the same is in the ‘neutral/normal’ closed position. The offset is aptly less than or equal to 0.4 mm. This arrangement provides support to the valve flap if/when it is urged beyond the closed position by a negative pressure created across the valve flap in use, to prevent the same from collapsing/buckling, whilst also limits the contact area on the valve flap in the ‘normal closed position to only the seat surface to thereby minimise the risk of the valve flap sticking in the closed position in use.

The support surfaces 167 aptly have a width which is less than a width of the main portion 163 of the respective cross member 162. The support surfaces 167 may be rounded. This arrangement minimises the contact area of the support surfaces 167 and thereby the risk of the flap valve sticking to the support surfaces in use and in turn requiring an increased pressure to move the flap valve back towards the open position. The Y-arrangement of cross members 162 desirably supports the flap valve 106 at the free end corner regions thereof which are furthest away from the fixed end region of the valve flap and therefore at greater risk of inversion by a negative pressure than, for example, a central or proximal region of the flap valve with respect to the fixed end thereof. The central region of the flap valve is supported in the over-closed position by the central portion of the Y-arrangement of cross members and the proximal region of the valve flap is supported centrally along the longitudinal axis by the proximal cross member with respect to the fixed end of the valve flap. This arrangement provides sufficient support to the flap valve in the over-closed position, whilst maximising air flow through the valve assembly and minimising resistance to the airflow through the valve assembly.

As illustrated in FIGS. 2a and 2b, each flap support portion 165 is spaced away from the second wall portion 154 defining the orifice to provide a gap 168 therebetween and isolate the support surface 167 provided by each cross member 162 from the valve seat 156. The gaps 168 allow air to flow through and help to prevent an adhesion force being created between the flap valve and the support surfaces 167.

The valve cover member 102 is a one-piece moulded component and includes a peripheral flange region 170 defining the flange surface 126 for engagement with the corresponding flange surface 124 of the valve seat member 104 when the two components are assembled together. An inwardly tapered and peripheral cover wall region 172 extends from the flange region 170 to define the tapered inner surface 122 for engagement with the corresponding inner surface 120 of the valve seat member 104 when the two components are assembled together. A cover closure region 174 extends across the cover wall region 172 to close an end region thereof which is distal to and opposite the valve orifice. As illustrated in FIG. 2a, the cover closure region 174 defines a plurality of spaced apart and parallel ribs 176 disposed on an inner surface thereof. The ribs 176 extend laterally with respect to the valve flap 106 and each have a length which is less than a width of the valve flap. The ribs 176 present a smaller combined contact area compared to if they were not present for the flap valve 106 to engage when in the fully open position or even if urged beyond a normal open position. Presenting a relatively small contact area to the flap valve when in the open, or over-open, position, the risk of the valve flap undesirably sticking to the underside of the cover closure region 174 is minimised if not eliminated. The ribs 176 space the valve flap 106 away from the underside of the cover closure region 174 and air is allowed to flow between the valve flap and the cover member, and between the ribs, if the valve flap is forced against the ribs to thereby ensure the flap does not stick to the same, particularly if moisture is present on the ribs in use. In view of the length of each rib 176 being less than a width of the valve flap 106, the side regions and free end region of the valve flap 106 is not engaged with any other component when in the open or an over-open position which desirably further reduces the risk of the valve flap sticking to a surface of the valve cover member 102 in use.

As illustrated in FIG. 1, a plurality of apertures is defined in the cover wall region 172 of the valve cover member 102 which include a pair of opposed elongate side apertures 178, an elongate distal aperture 180, and a pair of corner apertures 182. The side apertures 178 and distal aperture 180 are substantially rectangular in shape and the corner apertures 182 are substantially square in shape. The side apertures 178 are substantially aligned with the elongate proximal/side ports 164 of the valve seat member 104 and have a length substantially corresponding to a length of the proximal/side ports 164. The distal aperture 180 is substantially aligned with the distal port 166 of the valve seat member 104 and has a length substantially corresponding to a length of the distal port 166. Each corner aperture 182 communicates with the distal port 166 and a respective one of the proximal/side ports 164. This arrangement, i.e. location and size and shape, of the apertures 178,180,182 in the valve cover member 102 ensures optimum air flow through the valve assembly in use, whilst minimising resistance to said air flow and in turn the breathing of a person wearing the face mask. In use, the distal aperture 180 in the valve cover member 102 faces substantially downwardly such that air being expelled from the valve assembly (when configured as an exhale valve assembly) is directed substantially away from a wearer's eyes so that the risk of steaming up a visor or eyewear also being worn by the person is minimised if not eliminated.

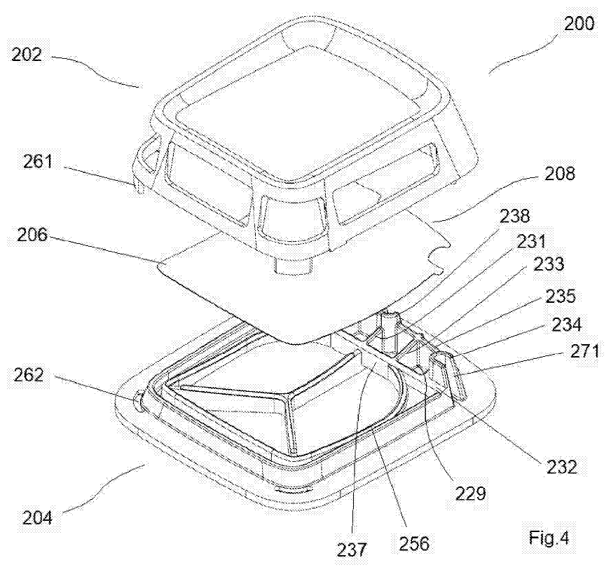

A respirator valve assembly 200 for a filtering face mask according to an alternative embodiment of the present invention is illustrated in FIGS. 4 to 7.

As illustrated in FIG. 4, the proximal end region of the first wall portion 218 of the valve seat member 204 includes a plurality of scalloped regions/recesses 229 extending downwardly therein from the mounting surface 232 to thereby define a plurality of ribs 231,233 for engaging and supporting the underside of the fixed end region 208 of the valve flap 206. The ribs include a central rib 231 located between a pair of side ribs 233, wherein the ribs extend substantially longitudinally between a rear laterally oriented rib 235 and a front laterally oriented rib 237. The ribs collectively define the mounting surface 232 for engaging and supporting the underside of the fixed end region 208 of the valve flap 206. Reversing the moulding direction compared to the embodiment illustrated in FIGS. 1 to 3 which includes a single recess (179 in FIGS. 2a and 3) extending inwardly from the under surface of the valve seat member 104, desirably maximises the flat surface area of the underside of the valve seat member 204 to increase security if the valve assembly 200 is adhered to a corresponding surface of a filtering face mask.

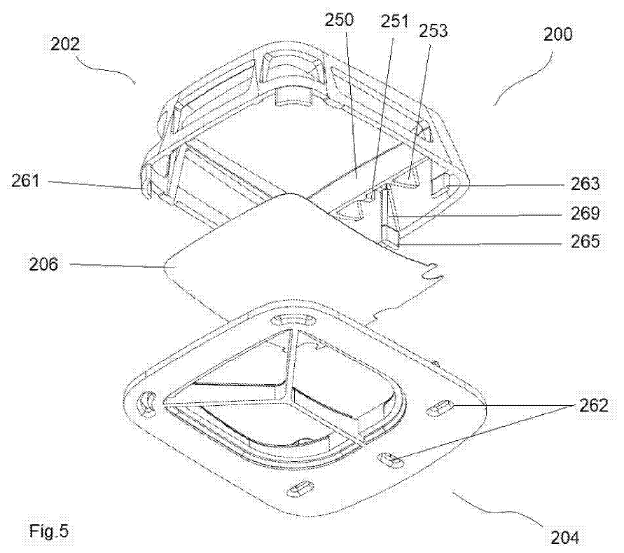

As illustrated in FIG. 5, the valve cover member 202 of the valve assembly 200 includes a plurality of longitudinally oriented and laterally spaced apart ribs 251, 253 which are respectively in alignment with the central rib 231 and the side ribs 233 of the valve seat member 204 for engagement with the upper surface of the valve flap 206 to securely clamp the fixed end region 208 of the valve flap 206 therebetween. The longitudinally oriented ribs 251,253 extend rearwardly from a laterally oriented wall/projection 250 extending across the inside of the valve cover member 202 which corresponds with the front laterally oriented rib 237 of the valve seat member 204 to thereby clamp the fixed end region 208 of the valve flap 206 therebetween.

As illustrated in FIG. 4, the side regions of the valve seat 256 curve gradually into the front laterally oriented rib 237 such that the mounting surface 232 extends onto the valve seat 256 without a gap therebetween. The curved proximal corner regions of the valve seat 256 have in profile a radius of curvature of around 8 mm. This arrangement uses a distal portion (front laterally oriented rib 237) of the mounting/clamping surface 232 as a proximal end surface of the valve seat 256 which in turn increases sealing efficiency and responsiveness of the valve flap and reduces the risk of leakage past the valve flap in use. The larger radii of the curved proximal corner regions of the valve seat 256 also help to reduce the risk of leakage past the valve flap in use.

As illustrated in FIG. 5, the valve cover member 202 includes a plurality of projections 261,263 extending downwardly therefrom for locating in corresponding through apertures 262 provided in the valve seat member 204. As illustrated, a distal projection 261 extends from the underside of each of the front/distal corners of the cover wall region 272 of the valve cover member 202, and a pair of side proximal projections 263 and a central proximal projection 265 located therebetween extend from respective truss regions 269 extending inwardly from the inner surface of the valve cover member 202. The side projections 263 are oriented laterally and the central projection 265 is oriented longitudinally. The truss regions 269 are slidably received in correspondingly shaped and sized bores 271 which extend axially through each locating projection 234,238 and terminate at a respective one of the proximal apertures 262. As described above for the embodiment illustrated in FIGS. 1 to 3, the locating projections 234,238 locate and constrain the valve flap 206 on the mounting surface 232 in both the longitudinal and lateral directions. Engagement of the valve cover projections 261,263,265 into the corresponding bores 271 and through the corresponding apertures 262 of the valve seat member 204 positively locates and couples the valve cover member 202 with respect to the valve seat member 204 prior to welding the two components together.

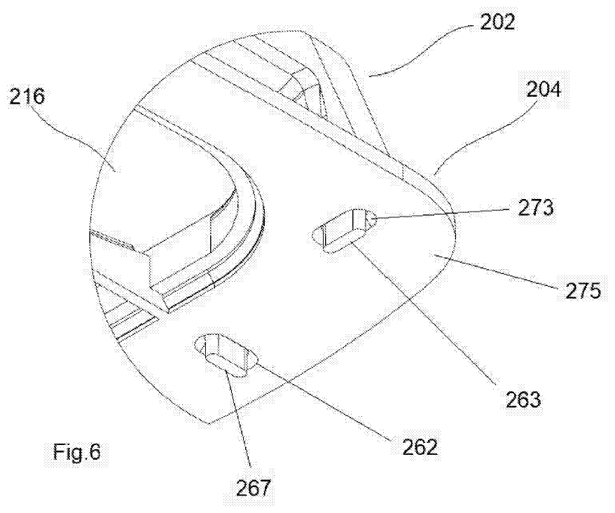

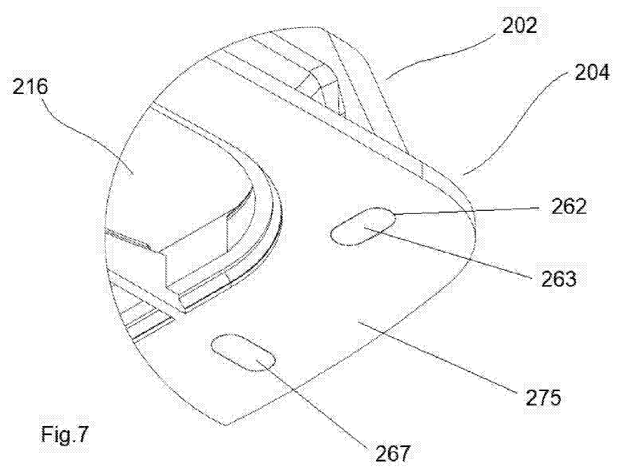

As illustrated in FIG. 6, the valve cover projections 261,263,265 extend through the apertures 262 when the valve cover member 202 is mounted on the valve seat member 204 during assembly. Each aperture 262 includes a countersunk region 273, i.e. an inwardly tapering surface, extending into the under surface 275 of the valve seat member 204. The ends of the projections 265,267 extending through the apertures 262 are then subjected to localised energy, such as high frequency ultrasonic acoustic vibrations, or localised heating by, for example, heat staking or the like, to cause the plastics material at the ends of each projection to deform and fill the countersunk regions 273 of each respective aperture 262 such that, as illustrated in FIG. 7, a substantially flat under surface is provided. The surface material of the countersunk regions 273 may aptly also be caused to soften/deform such that, once cooled and hardened, a solid homogenous weld between the two components is created. The countersunk regions 273 also create a tapered formation at the end of each projection 261,263,265 which securely anchors the valve cover member 202 to the valve cover seat 204 and prevents separation in use.

Certain embodiments of the present invention therefore provide a valve assembly for a filtering face mask which is non-complex to manufacture, assemble and use. The illustrated valve assembly is an exhalation valve assembly wherein the valve flap opens in response to a wearer exhaling through the valve assembly; however, the valve assembly may be configured to be used as an inhale valve assembly wherein the valve flap opens in response to a wearer inhaling through the valve assembly.

The valve assembly is configured to be securely and efficiently mounted to a face mask and is compact. The structure of the valve assembly has been optimised to be strong and stiff whilst reducing weight and material used. The Y-shaped arrangement of cross members for example provides strength and stiffness to the valve seat member whilst minimising the resistance to air flowing through the valve assembly in use and in turn any undesirable resistance to breathing for the wearer. The valve assembly according to certain embodiments of the present invention is also configured to minimise/eliminate the risk of the valve flap undesirably sticking to a surface of the valve assembly if, for example, condensation or moisture built up on the surface. The valve assembly is also configured to allow the valve flap to flex in the longitudinal direction only and thus in a substantially natural manner which prolongs the life of the valve flap and in turn the valve assembly itself. The valve assembly is also configured to bias the valve flap against the valve seat to ensure an efficient seal is created between the valve flap and the valve seat when the valve flap is in the closed position and a pressure differential across the valve flap is substantially zero, whilst also ensuring the valve flap remains closed whilst the pressure differential is zero and in any orientation of the valve assembly. The valve assembly is also configured to support the valve flap and prevent the same from collapsing/buckling if/when the same is urged beyond the ‘neutral’ closed position when a negative pressure is created across the valve flap by, for example, continued inhalation by the wearer.

1. A unidirectional valve assembly for a face mask, comprising:
a valve seat member providing a continuous valve seat surface surrounding a non-circular valve orifice, and a plurality of cross members each extending partially across the valve orifice to meet at an intersection region;
a substantially flexible and cantilevered valve flap mounted at a fixed end region to the valve seat member and configured to engage the valve seat when in a closed position to prevent air flow through the valve assembly; and
a valve cover member attached to the valve seat member and defining a plurality of apertures in fluid communication with the valve orifice when at least a free end region of the valve flap is in an open position with respect to the valve seat to allow air flow through the valve assembly,
wherein the cross members are arranged in a Y-shape configuration and comprise a first cross member extending from a first corner region of the valve orifice, a second cross member extending from a second corner region of the valve orifice, and a third cross member extending substantially longitudinally with respect to an axis of the valve flap and away from the first and second corner regions of the valve orifice.

2. The valve assembly according to claim 1, wherein the valve orifice is substantially square.

3. The valve assembly according to claim 1, wherein the cross members split the valve orifice into a pair of opposed first and second side ports extending from a proximal end of the orifice towards a distal end of the orifice with respect to the fixed end region of the valve flap, and a distal end port extending across the distal end of the orifice.

4. The valve assembly according to claim 3, wherein the plurality of apertures of the valve cover member comprises a first side aperture substantially aligned with the first side port, a second side aperture substantially aligned with the second side port, and a distal end aperture substantially aligned with the distal end port.

5. The valve assembly according to claim 4, wherein the valve cover member comprises a pair of opposed corner apertures each located between the distal end aperture and a respective one of the side apertures.

6. The valve assembly according to claim 4, wherein the apertures are disposed in a wall region of the valve cover member and a closure region extends across the wall region to close the valve assembly distal and substantially opposed to the valve orifice.

7. The valve assembly according to claim 6, wherein a plurality of spaced apart and parallel ribs extends inwardly towards the valve orifice from an inner surface of the closure region.

8. The valve assembly according to claim 7, wherein the ribs are oriented substantially laterally with respect to the longitudinal axis of the valve flap.

9. The valve assembly according to claim 1, wherein the valve seat surface comprises a pair of opposed side regions extending between proximal and distal end regions with respect to the fixed end region of the valve flap, and wherein the side regions of the valve seat surface are substantially concave.

10. The valve assembly according to claim 9, wherein the distal end region of the valve seat surface is located further away from the valve orifice than the proximal end region of the valve seat surface in a direction parallel to an axis of the valve orifice.

11. The valve assembly according to claim 9, wherein a flap support surface defined by the cross members is substantially concave and defines a curvature substantially corresponding to the curved side regions of the valve seat surface.

12. The valve assembly according to claim 11, wherein a width of the flap support surface along each cross member is less than a width of an underlying main portion of each cross member.

13. The valve assembly according to claim 11, wherein the flap support surface is spaced apart from the valve seat surface.

14. The valve assembly according to claim 1, wherein the intersection region of the cross members is offset with respect to a centre of the valve orifice.

15. The valve assembly according to claim 1, wherein the valve seat surface surrounding the valve orifice is substantially square.

16. The valve assembly according to claim 1, wherein the valve seat member comprises a mounting surface for mounting the fixed end region of the valve flap on, and the valve cover member comprises a clamping portion for clamping the fixed end region of the valve flap between the valve seat member and the valve cover member.

17. (canceled)

18. (canceled)

19. (canceled)

20. (canceled)

21. The valve assembly according to claim 1, wherein the valve cover member comprises a plurality of spaced apart projections for locating in corresponding apertures of the valve seat member during assembly, wherein the material of each projection is configured to deform when subjected to high frequency ultrasonic acoustic vibrations or heating to securely attach the valve cover member to the valve seat member.

22. The valve assembly according to claim 21, wherein each aperture comprises a countersunk region and each projection is configured to extend through the respective aperture before being caused to deform and to fill the countersunk region when deformed to thereby create a tapered formation at the end of each projection.

23. (canceled)

24. A face mask comprising a unidirectional valve assembly according to claim 1.

25. The face mask according to claim 24, wherein the valve assembly is configured to allow a wearer of the mask to exhale through the valve assembly.
